(19) United States
(12) Patent Application Publication
(10) Pub. No.: US 2001/0030043 A1
(43) Pub. Date: Oct. 18, 2001

(54) BRAZED PLATE HEAT EXCHANGER UTILIZING METAL GASKETS AND METHOD FOR MAKING SAME

(76) Inventors: WILLIAM T. GLEISLE, WEST SENECA, NY (US); GLEN HUBMAN, TONAWANDA, NY (US); GREGORY C. GRAFINGER, GRAND ISLAND, NY (US)

Correspondence Address: MENOTTI J LOMBARDI, ITT FLUID TECHNOLOGY, 10 MOUNTAINVIEW ROAD, UPPER SADDLE RIVER, NJ, 07458

(21) Appl. No.: 09/309,702

(22) Filed: May 11, 1999

(51) Int. Cl. F28F 3/08; B23P 15/26; B23K 31/00

(52) U.S. Cl. 165/167; 29/890.054

(57) ABSTRACT

A method of fabricating a plate heat exchanger comprising the steps of providing heat transfer plates having fluid passage openings therein; disposing a metallic gasket assembly of a predetermined configuration around the fluid passage openings and perimeter portions of each heat transfer plate; alternating the heat transfer plates in a stacked relationship in a reverse orientation to form a plurality of flow cavities defined by the surfaces of the heat transfer plates and the metallic gasket assemblies; positioning turbulator members having corrugated grooves within each of the flow cavities for causing fluid turbulence; applying a braze alloy around the metallic gasket assemblies and on the surface of the heat transfer plates; and heating the braze alloy coated heat transfer plates to sealingly interconnect with each metallic gasket assembly and with one another.

### FIELD OF INVENTION

The invention relates generally to devices used to transfer heat from one fluid to another and more particularly to a brazed plate heat exchanger having metal gaskets formed for fitting into gasket grooves of the heat exchanger plates.

### BACKGROUND OF THE INVENTION

Plate heat exchangers are used to transfer heat from one fluid to another through thin metal plates. Typically, plate heat exchangers may be divided into three general categories: 1) gasketed, 2) brazed and 3) welded. These categories describe the methods used to isolate fluids flowing within the heat exchanger from each other and to contain the fluids within the plate heat exchanger.

Gasketed plate exchangers use a compressible gasket of an elastomer material, around the perimeter and ports of thin metal plates to contain the fluids and direct hot and cold fluids across alternating plates. The entire stack of plates is then compressed between heavy metal covers by tightening a series of bolts around the outside edges. The covers and bolts compress the elastomeric gaskets to form a leak-tight seal and also to provide the mechanical strength required to contain fluid pressure within the heat exchanger.

Brazed plate exchangers are similar to elastomeric gasketed heat exchangers, but the gaskets and bolted covers may be eliminated. In place of elastomer gaskets, the thin metal heat transfer plates are sealed by brazing. Copper or nickel are typical brazing metals. Brazing serves a second function of metallurgically bonding the heat transfer plates to one another at numerous contact points throughout the plate stack. This makes the heat exchanger rigid and capable of containing internal pressure without using heavy bolted covers. Welded plate exchangers are similar to gasketed, but the elastomer gaskets have been eliminated by welding. The perimeters and ports of the thin metal heat transfer plates are sealed by welding adjacent plates together at these locations. Often, the plates are not joined together at any other points throughout the stack, so heavy cover plates and bolts are still used to provide strength for containing fluid pressure. However, each of the above-identified plate exchangers has significant disadvantages. For example, for the gasketed plate heat exchanger design, a significant problem in the design of the gaskets concerns the heavy, bolted covers.

Thin heat transfer plates are readily available in a wide variety of sizes and materials from numerous suppliers, providing a great deal of design flexibility. Any gasketed joint, however, is a potential source of fluid leakage. Available gasket materials limit applications to moderate fluid temperatures and pressures. Temperatures of 300° F. and pressures of 300 PSIG are considered approximate maximum design parameters. High temperatures or pressures result in shortened gasket life and frequent maintenance to replace leaking gaskets. Also, heat exchanger fluids are limited to those which are chemically compatible with available gasket materials. Exchanger cover plates and the bolting required to compress them are extremely heavy when large plate sizes or high fluid pressures are encountered.

While the brazed plate exchanger eliminates the need for both gaskets and bolted cover plates, a shortcoming of this design, as it currently exists, includes the necessity to produce special plate stampings to create perimeter and port joints which are suitable for brazing. These unique brazed plate stampings are not interchangeable with gasketed plates. Consequently, brazed plate exchangers are small in size (approximately 1.5 square feet or less per plate) due to the high cost of producing plate dies and tooling. Design flexibility is limited to a relatively small number of plate sizes.

The welded plate design eliminates gaskets but still requires the application of heavy cover plates with large bolting requirements to contain pressure. Shortcomings of this design are similar to the brazed plate design. Special plate stampings are required to produce perimeter and port joints that can be welded effectively. These plates are not interchangeable with gasketed plates. Additionally, special welding equipment and welding processes (such as laser welding) are required to produce leak-free joints.

The invention described herein incorporates standard, commercially available heat exchanger plates, with metal or wire “gaskets” formed to fit into gasket grooves formed in these plates, and furnace brazing to produce an economical brazed plate heat exchanger which eliminates many of the shortcomings of the plate heat exchangers identified above.

As previously discussed, elastomer gaskets have temperature, pressure and fluid compatibility limitations. The present invention eliminates all elastomeric, molded gaskets. In place of the prior art gaskets, a formed metal wire of appropriate diameter is used with channels formed in the plate. A brazing procedure results in a pressure-tight joint between the wires and plates. Moreover, cover plates are unnecessary with the present invention, thereby obviating the need for thick metal cover plates with heavy bolting. The entire stacked plate assembly is brazed into a rigid structure capable of containing internal fluid pressure. Also, there are no gaskets to be compressed by cover plates.

Finally, this invention eliminates the need for specially designed plates. This in turn eliminates expensive dies and tooling to produce special plates for brazing or welding. Standard heat transfer plates are used, which are readily available from a variety of manufacturers. The key element to successfully brazing standard heat transfer plates is the use of formed wires in place of gaskets. Considerable design flexibility in terms of plate size, plate style, and plate material is achieved at very low cost.

### SUMMARY OF THE INVENTION

It is an object of the present invention to provide in a brazed plate type heat exchanger comprising a plurality of heat transfer plates arranged in stacked relationship with one another, each heat transfer plate including a flow course opening extending therethrough and having a plurality of fluid ports, the flow course opening in communication with a first fluid port and a second fluid port of the plurality of fluid ports, at least one of the first and second fluid ports in fluid communication with a corresponding first and second fluid port associated with another heat transfer plate, and a turbulator member disposed within the flow course opening of each heat transfer plate, the improvement therewith comprising a metal gasket assembly disposed within channels of each heat transfer plate and extending around portions of the first and second fluid ports and the turbulator member for directing fluid across the flow course opening, the metal gasket assembly operative to sealingly couple to the channels of the heat transfer plate and to an adjacent heat transfer plate when the stacked heat transfer plates are brazed together.

It is a further object of the present invention to provide a method of fabricating a plate heat exchanger comprising the steps of providing heat transfer plates having fluid passage openings therein; disposing a metallic gasket assembly of a predetermined configuration around the fluid passage openings and perimeter portions of each heat transfer plate; alternating the heat transfer plates in a stacked relationship in a reverse orientation to form a plurality of flow cavities defined by the surfaces of the heat transfer plates and the metallic gasket assemblies;

positioning turbulator members having corrugated grooves within each of the flow cavities for causing fluid turbulence; applying a braze alloy around the metallic gasket assemblies and on the surface of the heat transfer plates; and heating the braze alloy coated heat transfer plates to sealingly interconnect with each metallic gasket assembly and with one another.

### BRIEF DESCRIPTION OF THE DRAWINGS

FIG. 1 is a perspective view of a brazed plate metal gasket heat exchanger according to the present invention.

FIG. 2 is a top view of the brazed plate heat exchanger as shown in FIG. 1.

FIG. 3 provides an illustration of fluid flow through the brazed plate heat exchanger shown in FIG. 1 according to the present invention.

FIG. 4 is a top view showing a metal gasket assembly according to the present invention.

FIGS. 5 and 6A-B show a cross-sectional view of a portion of the formed metal gasket assembly within the channel according to the present invention.

FIG. 6C shows a cross-sectional view of a formed gasket assembly having a substantially rectangular cross section according to another embodiment of the invention.

FIG. 7 shows a top view of the gasketed assembly having a different channel configuration according to an alternative embodiment of the present invention.

### DETAILED DESCRIPTION OF THE INVENTION

The basic concept of the present invention is a brazed plate heat exchanger utilizing a formed metal gasket assembly whereby a hot fluid transfers heat to a cold fluid through thin metal plates. The difference from the prior art heat transfer plate exchangers lies in its method of construction, which addresses the shortcomings of these other devices as described above.

Standard, commercially available heat transfer plates are used to take advantage of low cost and availability of many plate sizes, styles and materials. In place of elastomer gaskets, formed metal is used to create leak-tight perimeter and port joints by furnace brazing. Braze alloy is placed around the formed wire assembly and between each heat transfer plate to produce a rigid, internally supported plate stack capable of containing fluid pressure without the use of thick metal external heads and compression bolts.

Essentially, the brazed plate heat exchanger of the present invention comprises the following components: a) thin metal heat transfer plates which permit heat to be transferred between a hot and cold fluid without mixing. These plates may be similar or identical to plates used in elastomeric, molded gasketed exchangers. A wide variety of sizes, styles and materials are readily available; b) formed metal gaskets are used to seal the perimeter and ports of the heat exchanger. Metal is formed into the exact shape as gaskets are placed into gasket channels in the plates; c) braze alloy in either foil, paste or powder form is placed uniformly around the gaskets and between the heat transfer plates. As the braze alloy melts in a furnace it flows to every metal contact point in the assembly. Upon cooling and solidification, the metal gasket is sealed to the plates and the plates to each other at numerous contact points. Any suitable brazing metal can be used, however, nickel or copper braze alloy is preferred; d) top and bottom plates of thin metal (⅛″ thick or less) are furnace brazed to the stacked heat transfer plates. These plates provide a place for attachment of fluid connections to the plate stack.

Possible applications of this novel heat exchanger include: lithium bromide solution heat exchangers for absorption chillers; ammonia evaporators and condensers; deionized water heat exchangers; freon evaporators and condensers; heat exchangers for volatile organic compounds; and general process heating and cooling apparatus to name of few.

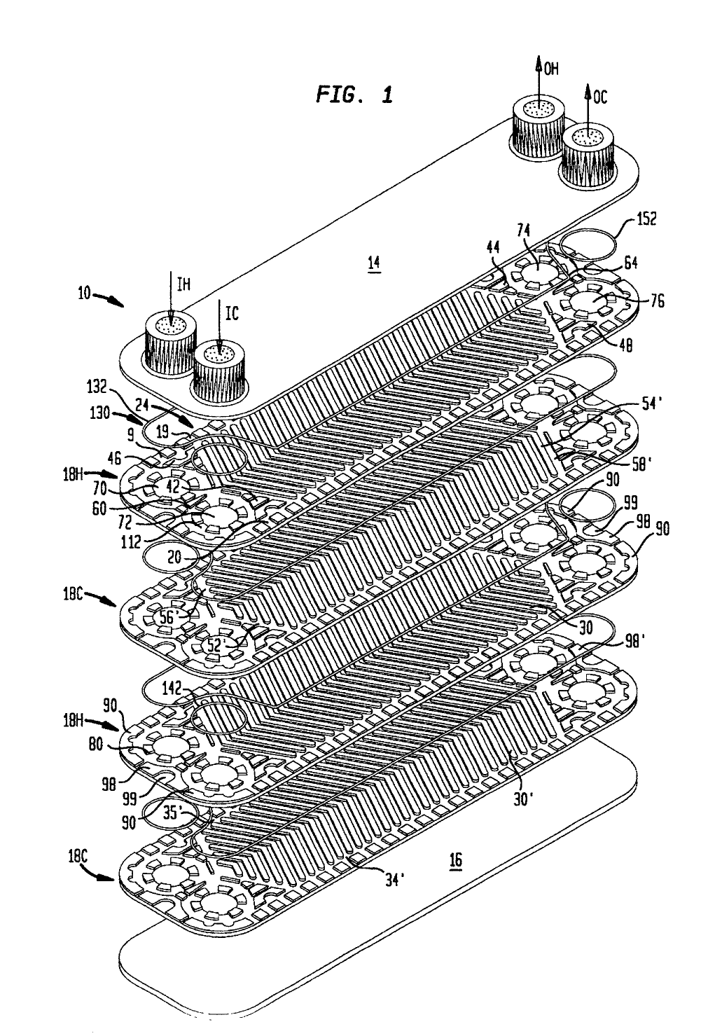

Referring now to FIG. 1, there is depicted a plate type heat exchanger 10 of the stacked plate type which includes a plurality of heat transfer plates 18H, 18C which permit heat to be transferred between a hot and cold fluid without mixing. When referring to the drawings, like parts are indicated by like reference numerals. The heat exchanger 10 comprises elongated, generally rectangular shaped, flat plate members stacked in superposed relation, one on the other, and including a top plate 14, a bottom plate 16, and alternating heat transfer plates 18H and 18C. Each heat transfer plate 18H and 18C includes a respective turbulator member 30, 30′ having substantially regular plan outlines of predetermined configuration selected from a plurality of different turbulator configurations available and related to the type of fluid used therewith. The turbulator serves to present obstruction to flow within each of the plates 18H and 18C, thereby causing creation of irregular and random fluid flow currents. This effect is to enhance heat transfer from or to the fluid flowing in the plate flow cavity 140. Each of the heat plates 18H and 18C are of a singular configuration but assembled in reverse orientation to permit the flow of a hot fluid across respective transfer plates 18H and a cold fluid across respective transfer plates 18C. For purposes of clarity, component descriptions associated with each of the heat plates will utilize the convention of an apostrophe (′) to denote like reference components associated with the cold heat transfer plate 18C as opposed to hot fluid transfer plates 18H.

As shown in FIG. 1, each of the heat transfer plates 18H, 18C further include a plurality of projections extending vertically from the top surface 19 of each heat transfer plate and arranged in a predetermined configuration around peripheral portions of flow openings 70, 72, 74, and 76 and around the perimeter of the turbulator member 30. Each of the flow openings, turbulator member, and the plurality of projections serve to define channels for gasketed grooves for receiving a formed metal gasket contoured to the shape of the channel in accordance with the present invention. Note that each of the projections arranged on the top surface of the heat transfer plate are of the same vertical height and have a substantially flat or planar top surface which is also coplanar with the top surface of the turbulator member so as to provide a uniform gasketed groove for receiving formed metal gasket, and which allows for uniform contact with an adjacent upper plate for providing a leak tight seal, as will be described in further detail later.

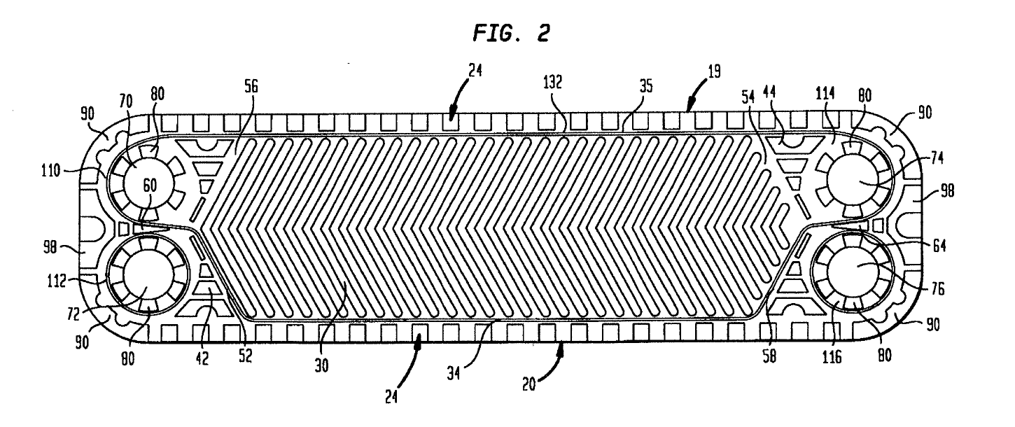

Still referring to FIG. 1, the plurality of projections include a series of substantially uniformly spaced, square-like projections 24 arranged on the top surface of each heat transfer plate and extending along oppositely disposed longitudinal portions 19, 20 thereof. Referring collectively to FIGS. 1 and 2, the location of projections 24 and the corresponding laterally extending end positions of turbulator member 30 form respective channel portions 34 and 35 longitudinally disposed along respective sides of each heat transfer plate. Note that FIG. 2 depicts a top view of a heat exchange plate having channels for receiving a formed metal gasket according to the present invention. Similarly, diagonally opposite projection members 42 and 44, as well as diagonally opposite projection members 46 and 48 operate in conjunction with the configuration of the turbulator member 30 to define respective channel portions 52, 54, 56 and 58. The configuration of each heat transfer plate 18H, 18C further includes oppositely disposed rectangular projection portions 60 and 64 which operate to separate or segment respective pairs of flow passages 70, 72 and 74, 76 from one another. That is, projection set 60 is interposed between separate flow passage 70 from 72, while projection set 64 acts to separate the two flow passages 74 and 76.

A series of uniformly spaced, upwardly extending projections 80 are arranged in a pattern around the peripheral edge of each of the flow passages 70, 72, 74, and 76. In addition, the set of substantially flat top, upwardly extending projections 90, each of the same shape and contoured to the curved perimeter portions of the heat transfer plate, and oppositely disposed triangular shaped projections 98, are positioned substantially between each of the respective pairs 90 of projections. Each member 98 includes a circular depression 99 located along the longitudinal center line of the rectangular plate, the depressions being positioned inside the respective projections. As mentioned previously, each of the above identified projections include a substantially flat top surface to which a brazen alloy material is applied so as to seal the adjacent plate located vertically above it in the stacked configuration.

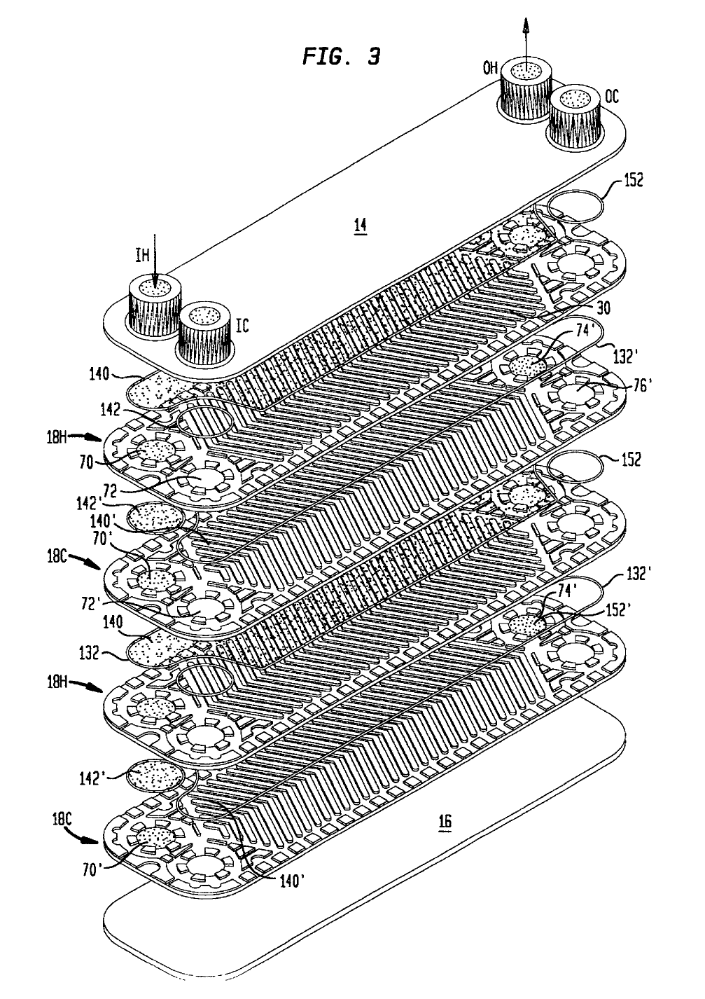

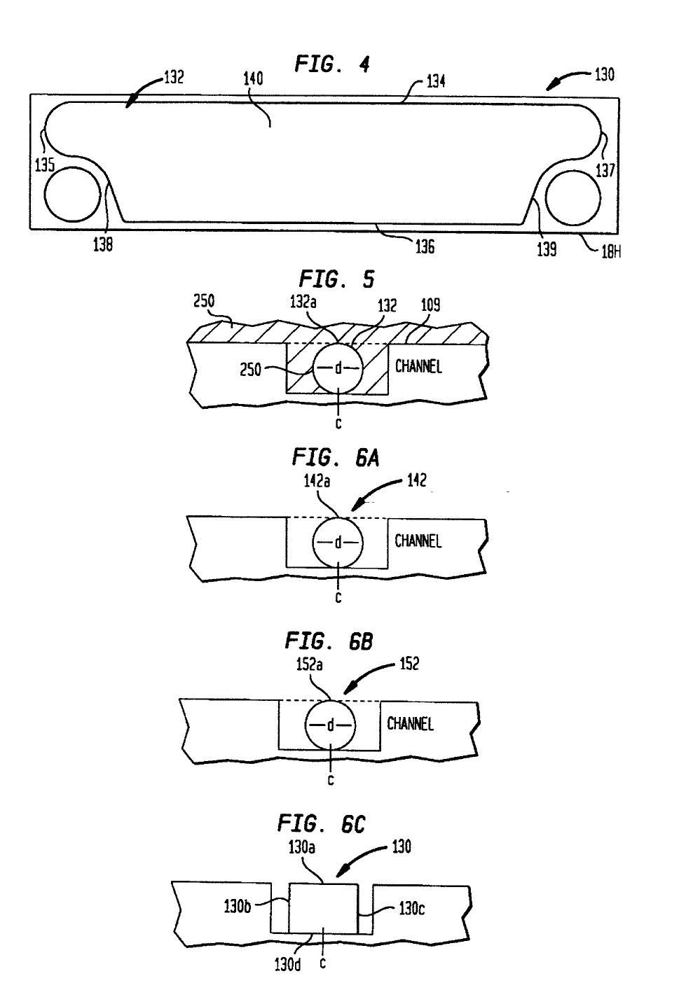

As one can ascertain from the preceding discussion and from the illustration of FIG. 1, the series of projections 90, 98, 60, 24, and 42 form a channel 112 around the periphery of flow passage 72. In similar fashion, channels 110, 114 and 116 peripherally extend and surround respective flow passages 70, 74, and 76. A metal gasket assembly 130 is then disposed in portions of each of the channels 34, 35, 52-58, and 110, 112, 114, 116 around the perimeter portions of the turbulator member 30 and each of the flow passages 70, 72, 74, and 76 for defining a flow cavity 140 (best seen in FIG. 3) in which the turbulator is disposed in and which extends across each of the heat transfer plates. FIG. 4 provides an illustration of the metal gasket assembly 130. The metal gasket assembly 130 is, in the preferred embodiment, made of stainless steel or titanium metal alloy and comprises a first closed metal loop 132 of formed wire disposed in each of the channels extending around the perimeter of the turbulator member, as well as a portion of two oppositely disposed flow passages. As shown in the preferred embodiment of FIGS. 1 and 2, the closed metal loop gasket 132 is disposed in a portion of the channels 110 and 114 corresponding to flow openings 70 and 74 respectively, and unitarily extends through channels 34, 35, 52 and 58.

The closed metal loop wire is formed to lie at substantially the center position C of each of the channels and has a diameter d sufficient to accommodate such position as shown in FIG. 5. Moreover, in the preferred embodiment, the formed metal loop 132 is substantially cylindrical, having a circular cross section as shown in FIG. 5, and having a top portion 139 which is planar with a top portion of the associated channel (i.e. top surface of the projections) as can be seen in FIG. 5. Thus, the formed closed metal loop 132 may be characterized as having oppositely disposed longitudinally extending portions 134 and 136, oppositely disposed curved portions 135, 137 which surround the portion of two of the flow passages and respective sloped portions 138 and 139 connecting respective portions 135, 136, and 136, 137 to form the closed loop around the turbulator defining the flow cavity 140.

A second closed metal loop gasket 142 and a third closed metal loop gasket 152 are each oppositely disposed and formed in respective channels 112 and 116. Each of these wire loops, like the first closed metal loop 132, are preferably with a circular diameter d cylindrical and placed in substantially the center of each of the respective channels. Furthermore, each of the loops 142 and 152 also have top portions 142A, 152A which are substantially planar with the associated top portions of each of the respective channels in which the loop is disposed as shown in FIGS. 6A-B. Accordingly, each of the closed metal loops 142 and 152 operate to completely isolate the corresponding flow passages from the remainder of the heat transfer plate by restricting the flow of a fluid only to an adjacent plate and not to any other portion of the present heat transfer plate. FIG. 3 illustrates the flow of a hot fluid across and through heat transfer plates 18H, 18C, where the portions labeled 140 illustrate the flow of fluid across flow cavity 140 via every other heat transfer plate.

Referring collectively to FIGS. 1-6, each of the second and third closed loop formed metal gaskets 142 and 152 used to seal a respective flow opening associated with a particular heat transfer plate, is made of stainless steel or titanium alloy. A brazed alloy 250 (see FIG. 5), such as nickel or copper, is then placed uniformly around each of the metal loops 132, 142, and 152 and on each of the projections disposed on the associated heat transfer plate. When all of the plate components and turbulators as described above have been arranged in stacked assembly, the assembly is then placed in an oven or like brazing environment, to heat the assembly until the braze alloy becomes molten sufficiently to affect connection joinder of the components of the unitary structure, with the spaces between the plates having a fluid tight seal. As the braze alloy melts in the furnace, it flows to every metal contact point within the assembly. Thus, upon cooling each of the metal loops is sealed to the plate and the plates to each other at numerous contact points. The braze alloy used may be in either foil, paste, or powder form in order to affix the structure together. Note that brazing procedures are well known and will not be described further. U.S. Pat. No. 4,006,776 is referred to as an example of a brazing process which can be used for such purpose. Note that top and bottom plates 14 and 16 are stacked and brazed assembled to provide top and bottom closures for the heat exchange system 10 as shown in FIG. 1.

FIGS. 1 and 3 also illustrate how the various plate components can be apertured or provided with openings to establish two separate fluid flow passage networks present in this heat exchanger. The top plate 14 and each heat transfer plate 18H, 18C are punched to have identically sized and located fluid passage openings 74″, 76″ at an end thereof and a similar pair of openings 70″, 72″ at the other end. The said openings being located each proximate comers of its associated components. The heat transfer plates 18H and 18C have pairs of flow passages directly opposite one another at opposite ends of the rectangular plate which are in direct vertical alignment with one another. Two of the flow passages (e.g. 72 and 76 of 18H) are alongside of and isolated from the respective flow course 140 in 18H by the corresponding second and third metal loop gaskets 142 and 152. Threaded nipples IH and OH are brazed to the top plate and provide means for connecting the heat exchanger to the heated fluid origin. The same arrangement applies to the cooling fluid flow passage network in aligned openings 76′ and 72′ and flow cavity 140′ in plate 18C aligned to constitute the cooling fluid passage network which communicates with nipples IC and OC in the top plate. It would be appreciated that a variety of types of inlet and outlet arrangements for fluid flow to and from the heat exchanger are possible.

While the depicted heat exchanger construction involves counter-current flow between the two fluids in the heat transfer cell, the same structure could also be employed if concurrent fluid flow is desired by simply connecting the inlets and the outlets for the two fluids at corresponding ends of the heat exchanger. Various ways to provide multiple passage of either hot or cold side flow would be understood by those skilled in the art.

As shown in FIGS. 1 and 3, operation of heat exchanger is described briefly as follows. Hot input fluid is entered into heat exchanger 10 via nipple IH from top plate 14. The fluid enters heat plate 18H at flow passage 70 and proceeds across flow course opening 140 of heat transfer plate 18H by means of turbulator member 30 to flow passage opening 74 at the opposite end of plate 18H. The contoured, formed metal gasket 132 operates to direct the fluid flow across the flow course opening and to restrict the fluid from the other portions of the heat transfer plate. The fluid from nipple IH also passes through heat transfer plate 18H via passage opening 70 down to the next heat transfer plate 18H via opening 70′ of plate 18C. The fluid passes across second heat transfer plate 18H (via flow course 140) to fluid passage 74 where it proceeds down to the second plate 18C via the vertically aligned passage openings 70′ and 74′. The heat transfer plate 18C is identical to heat transfer plate 18H except it is assembled in reverse orientation so that the flow course openings of 18C are ultimately communicated with other heat transfer plate flow course openings. That is, the heat transfer plate 18C second metal gasket loop 142′ is disposed completely around the periphery of flow passage 70′, while the third closed gasket loop 152′ is disposed completely surrounding the periphery of flow passage 74′. In this manner, both flow passages 70′ and 74′ are completely sealed and hence, cannot transfer fluid across plate 18C. Instead, fluid flow passes vertically via passages 70′ and 74′ to subsequent heat transfer plate 18H located beneath. The first metal loop gasket 132′ disposed within the associated channels on the first cold heat transfer plate 18C, as one can ascertain, surrounds the perimeter of 18C in the manner previously described for heat plate 18H to allow fluid passage across the flow course opening 140′ of plate 18C via respective flow openings 72′ and 76′ associated with the cooling fluid passage network in communication with nipples IC and AC.

The progression of hot and cold fluids occurs in similar fashion in the remainder of the alternating hot and cold transfer plates to permit heat to be transferred between the respective hot and cold fluids without mixing. Note that for fabrication of the heat exchanger, no special or costly practice is involved. The bottom, top, and heat exchange plates can be uniform and of the same thickness. For example, 12-gauge carbon or stainless steel plate stock, as well as titanium. These plates will be provided in a variety of sizes as is well known in the art, including 12⅜ by 4⅝ inches or in other convenient sizes as well. The projection configuration by which each of the channels is formed may also be modified as well, depending on the particular application. Standard, commercially available heat transfer plates may be used as previously mentioned, with the formed metal gasket assembly of wire loops 132, 142, and 152 used to create a loop type perimeter and port joints by means of furnace brazing. The braze alloys placed between each of the heat transfer plates produces a rigid internally supported plate stack capable of containing fluid pressure without the use of thick metal external heads or compression bolts.

In assembling and fabricating the brazed plate heat exchanger, heat transfer plates are provided having the fluid passage openings 70, 72, 74, and 76 formed therein for transferring fluids between plates. Each of the above-described sets of projections are disposed on a top surface of the heat transfer plate forming channels and the metal gasket assembly 132 having a predetermined configuration is formed around the fluid passage openings and perimeter portions of the heat transfer plate. The heat transfer plates are of single configuration. The heat transfer plates are then alternately arranged in reverse orientation to form a plurality of flow cavities which are defined by the surfaces of the heat transfer plate and the metallic gasket assembly. Turbulator members having corrugated grooves therein, are positioned within each of the flow cavities to cause fluid turbulence. Note that alternately placing reverse oriented heat transfer plates (i.e. 18H, 18C, 18H, etc . . . ) affects the proper flow communication of each with its respective heating or cooling fluid passage network. A braze alloy is then applied, preferably uniformly, around each of the wire loops 132, 142, 152 for each of the heat transfer plates, as well as over the top surface of the heat transfer plate and the assembly is heated to cause furnace brazing so that each of the heat transfer plates sealingly interconnect with each other and with the associated formed metal gasket assemblies. Note that as previously described, closed metal loop 132 disposed in the channel extending around the perimeter of the turbulator member 30 and oppositely disposed fluid passage openings 70 and 74 (or conversely 72 and 76) thereby defining the flow cavity 140 for fluidically isolating the flow course opening with the turbulator member and the two flow passage openings from the remainder of the heat transfer plate.

Note further that each of the closed metal loops is disposed in substantially the center position of the associated channel and is mechanically retained therein until furnace brazing occurs.

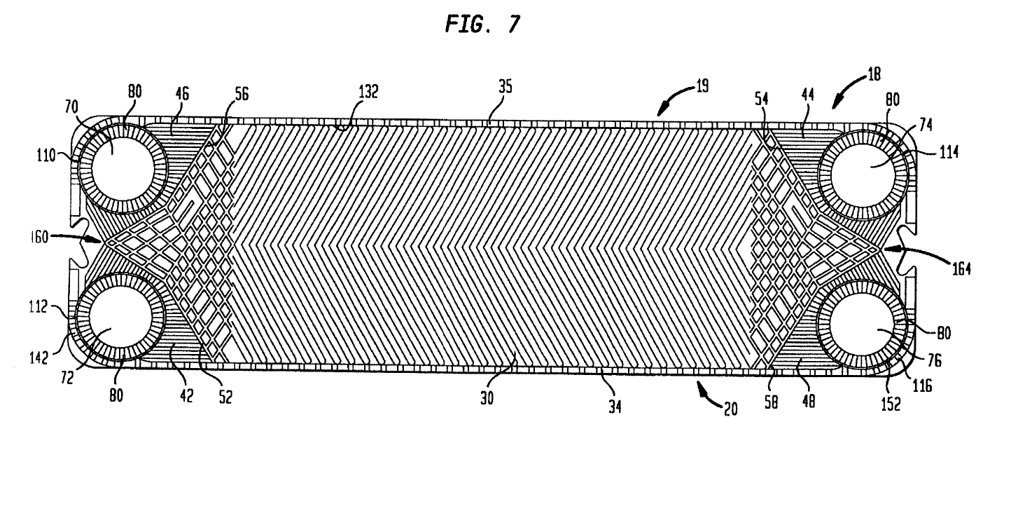

It should be understood that the embodiments described herein are exemplary and that a person skilled in the art may make many variations and modifications to these embodiments, utilizing functionally equivalent elements to those described herein. For example, while each of the metal loops may be mechanically retained within the center of their associated channels, the formed gaskets may also be retained by other means including adhesives, welding, etc. to secure the formed gaskets at the appropriate position prior to furnace brazing. Furthermore, a wide variety of gasketed configurations may be used and/or formed within a heat transfer plate to provide a plate seal or connection. FIG. 7 provides an alternative embodiment showing gasketed channels formed therein and intersecting at positions 160 and 164 at oppositely disposed position locations 160 and 164. Various other gasket channels and/or configurations for selectively allowing flow access across the heat transfer plate while isolating the remainder of the heat transfer plate are also contemplated. Still further, while the formed metal gasket assembly may comprise a cylindrical shaped wire having a substantially circular diameter disposed within the associated channel, other wire configurations are also envisioned. Such configuration as shown in FIG. 6C illustrates a substantially rectangular or bar-shaped metal gasket 130 having a flat top surface 130A planar with the top and associated projections or channels, as well as having substantially planar bottom surface 130D and side surfaces 130B and C formed to fit within the channel. Other configurations are also contemplated including oval or elliptical shaped metal gaskets. In addition, while there has been described a metal gasket assembly comprising three separate formed metal wire gaskets, other embodiments may include a monolithic wire assembly stamped or formed to the channels associated with a particular gasket configuration of a heat transfer plate, as well as the formation of a metal gasketed assembly having a portions welded together or unitarily connected by some other fashion to achieve the desired goal of sealing the perimeters and joints while requiring no additional compression assembly such as bolts or covers. Any and all such variations or modifications, as well as others which may become apparent to those skilled in the art, are intended to be included within the scope of the invention as defined by the appended claims.

What is claimed is:

1. In a brazed plate type heat exchanger comprising a plurality of heat transfer plates arranged in stacked relationship with one another, each said heat transfer plate including a flow course opening extending therethrough and having a plurality of fluid ports, said flow course opening in communication with a first fluid port and a second fluid port of said plurality of fluid ports, at least one of said first and second fluid ports in fluid communication with a corresponding first and second fluid port associated with another heat transfer plate, and a turbulator member disposed within said flow course opening of each said heat transfer plate, the improvement therewith comprising:
a metal gasket assembly disposed within channels of each said heat transfer plate and extending around portions of said first and second fluid ports and said turbulator member for directing fluid across said flow course opening, said metal gasket assembly operative to sealingly couple to said channels of said heat transfer plate and to an adjacent heat transfer plate when said stacked heat transfer plates are brazed together.

2. The brazed plate type heat exchanger according to claim 1, wherein said metal gasket assembly comprises a first closed metal loop formed in a channel and extending around a perimeter of said turbulator member and said first and second fluid ports to define said flow course opening to isolate said turbulator member and said first and second fluid ports from the remainder of said heat transfer plate.

3. The brazed plate type heat exchanger according to claim 2, wherein said plurality of fluid ports further includes a third fluid port having a channel formed around a periphery thereof, and wherein said metal gasket assembly further comprises a second closed metal loop formed in said peripheral channel surrounding said third fluid port to isolate said third fluid port from said flow course opening.

4. The brazed plate type heat exchanger according to claim 3, wherein said plurality of fluid ports further includes a fourth fluid port having a channel formed around a periphery thereof, and wherein said metal gasket assembly further comprises a third closed metal loop formed in said peripheral channel surrounding said fourth fluid port to isolate said fourth fluid port.

5. The brazed plate type heat exchanger according to claim 4, wherein each of said first, second and third closed metal loops are disposed within said channels at a depth such that a top portion of each said closed metal loop is substantially planar with a top portion of said associated channel.

6. The brazed plate type heat exchanger according to claim 5, wherein each of said closed metal loops are positioned substantially at a center position of said associated channel.

7. The brazed plate type heat exchanger according to claim 1, wherein said metal gasket assembly is made of stainless steel.

8. The brazed plate type heat exchanger according to claim 2, wherein said first closed metal loop is formed of a metal wire having a substantially circular cross section.

9. The brazed plate type heat exchanger according to claim 2, wherein said first closed metal loop is formed of a metal wire having a substantially flat top portion planar with a top portion of said associated channel.

10. The brazed plate type heat exchanger according to claim 1, wherein said metal gasket assembly is made of titanium, or other desired metal alloy.

11. The stacked plate heat exchanger according to claim 1, wherein said adjacent heat transfer plates are interconnected to one another by a layer of braze alloy material adhered to the adjoining faces of each said plate.

12. The stacked plate heat exchanger according to claim 11, wherein said braze alloy material is in the form of a foil, paste, or powder.

13. The brazed plate type heat exchanger according to claim 1, further comprising top and bottom plates connected, respectively, to two of said heat transfer plates.

14. The brazed plate type heat exchanger according to claim 13, further including first and second fluid inlets and outlets located in said top plate, said first fluid inlet being in fluid communication with the flow course opening of one of said heat transfer plates, said second fluid inlet being in fluid communication with another flow course opening of another of said heat transfer plates.

15. A method of fabricating a plate heat exchanger comprising the steps of:
providing heat transfer plates having fluid passage openings therein;
disposing a metallic gasket assembly of a predetermined configuration around said fluid passage openings and perimeter portions of each said heat transfer plate;
alternating said heat transfer plates in a stacked relationship in a reverse orientation to form a plurality of flow cavities defined by the surfaces of said heat transfer plates and said metallic gasket assemblies;
positioning turbulator members having corrugated grooves within each of said flow cavities for causing fluid turbulence;
applying a braze alloy around said metallic gasket assemblies and on the surface of said heat transfer plates; and
heating said braze alloy coated heat transfer plates to sealingly interconnect with each said metallic gasket assembly and with one another.

16. The method according to claim 15, wherein the step of disposing a metal gasket assembly around said fluid passage openings and perimeter portions of each said heat transfer plate further comprises the steps of:
disposing a first closed metal loop in a channel extending around a perimeter of said turbulator member and first and second fluid passage openings to define said flow cavity which fluidically isolates said flow cavity from the remainder of said heat transfer plate;
disposing a second closed metal loop in a channel extending around a perimeter of a third fluid passage opening to fluidically isolate said third fluid passage from the remainder of said heat transfer plate; and
disposing a third closed metal loop in a channel extending around a perimeter of a fourth fluid passage opening to fluidically isolate said fourth fluid passage from the remainder of said heat transfer plate; wherein said third and fourth fluid passage openings operate to transfer fluid to and from adjacent stacked plates, wherein when said heating step is applied, each of said first, second and third wire loops is sealed to said heat transfer plate and to the adjacent heat transfer plate via said brazed alloy.

17. The method according to claim 16, wherein each of said first, second and third closed metal loops has a substantially circular cross section and a top portion planarized with a top of said associated channel.

18. The method according to claim 15, wherein said metal gasket assembly is made of stainless steel, or other metal alloy.

19. The method according to claim 16, wherein said first closed metal loop is disposed in substantially a center position of said associated channel and mechanically retained therein until said heating step.

20. A metallic gasket heat exchanger comprising:
a plurality of heat transfer plates arranged in stacked relationship with one another, each said heat transfer plate having a plurality of fluid passage openings therein;
a metallic gasket assembly disposed on each said heat transfer plate and arranged in a pattern around said fluid passage openings and perimeter portions of each said heat transfer plate to define a flow cavity for transferring fluid between at least a first and second passage opening of said plurality of fluid passage openings;
a turbulator member disposed in said flow cavity of each said heat transfer plate for causing turbulent flow conditions across said heat transfer plate;
means for introducing a fluid into one of said heat exchange plates for transfer through said corresponding flow cavity via said at least first and second passage openings;
means for introducing a second fluid into another of said heat exchange plates for passage through said corresponding flow cavity via said at least first and second passage openings;
wherein at least one of said first and second passage openings associated with one heat transfer plate is in fluid communication with another of said first and second passage openings associated with another said heat transfer plate; and
wherein adjacent heat transfer plates are brazed together such that each said metal gasket assembly is sealed to the heat transfer plate disposed thereon and to the adjacent heat transfer plate such that the heat transfer plates are sealingly coupled to one another.

21. The metallic gasket heat exchanger according to claim 20, further comprising top and bottom plates connected, respectively, to two of said heat transfer plates.

22. The metallic gasket heat exchanger according to claim 21, including first and second fluid inlets and outlets located in said top plate, said first fluid inlet being in fluid communication with the flow course opening of one of said heat transfer plates, said second fluid inlet being in fluid communication with the flow course opening of another of said heat transfer plates.

22. The metallic gasket heat exchanger according to claim 21, wherein each of said heat transfer plates is of rectangular profile.

23. The metallic gasket heat exchanger according to claim 22, wherein said heat transfer plates are of a single configuration whereby alternately arranged ones thereof are positioned in reverse orientation to alternately communicate the flow course openings with said first and second fluid inlets.

24. The metallic gasket heat exchanger according to claim 20, wherein said metallic gasket assembly comprises:
a first closed wire loop formed in a channel and extending around a perimeter of said turbulator member and said first and second passage openings to define said flow course opening to isolate said turbulator member and said first and second passage openings from the remainder of said heat transfer plate;
a second closed metal loop formed in a peripheral channel surrounding a third passage opening in said heat transfer plate to isolate said third passage opening from said flow course opening; and
a third closed metal loop formed in a peripheral channel surrounding a fourth passage opening in said heat transfer plate to isolate said fourth passage opening from the remainder of said heat transfer plate; wherein said third and fourth passage openings surrounded by respective second and third closed metal loops operate to transfer fluid only to adjacent heat transfer plates in said stacked configuration.

25. The metallic gasket heat exchanger according to claim 24, wherein each of said second and third wire loops is of a substantially circular configuration and having a substantially circular cross section wherein a top portion is substantially planar with a top portion of said associated peripheral channel.

26. The metallic gasket heat exchanger according to claim 24, wherein said first wire loop has a substantially circular cross section wherein a top portion is substantially planar with a top portion of said associated peripheral channel, and wherein said first wire loop comprises first and second longitudinally extending portions in substantially parallel arrangement with one another and extending along opposing sides of said turbulator member, and third and fourth oppositely disposed arcuate portions oppositely extending along peripheral portions of respective first and second passage openings.

27. The metallic gasket heat exchanger according to claim 24, wherein at least one of said first, second and third closed wire loops is made of stainless steel or other metal alloy.
